(19) United States
(12) Patent Application Publication
(10) Pub. No.: US 2018/0329409 A1
(43) Pub. Date: Nov. 15, 2018

(54) PORTABLE MOBILE ROBOT AND OPERATION THEREOF

(71) Applicant: Bot3, Inc., Santa Clara, CA (US)

(72) Inventor: Chi-Min HUANG, Santa Clara, CA (US)

(21) Appl. No.: 15/834,227

(22) Filed: Dec. 7, 2017

Related U.S. Application Data
(63) Continuation-in-part of application No. 15/592,509, filed on May 11, 2017.

(51) Int. Cl. G05D 1/00; B25J 5/00; G05D 1/02

(52) U.S. Cl. CPC G05D 1/0011; B25J 5/007; Y10S 901/01; G05D 1/027; G05D 1/0231; G05D 1/0242

(57) ABSTRACT

The present invention discloses a portable mobile robot, including: a capture module, configured to capture location information of the portable mobile robot; a processor module, configured to draw a room map of the room based on the captured location information, and perform positioning, navigation, and path planning according to the room map; a control module, coupled to the processor module, configured to send a control signal to control movement of the portable mobile robot in the room along the a path according to the room map; a motion module, configured to control operation of a motor to drive the portable mobile robot according to the control signal; and a tray with a concave bottom, which is mounted on the top of the portable mobile robot. In the present invention, the portable mobile robot and operation method thereof can provide home interaction service.

### RELATED APPLICATION

This present application is a continuation-in-part of U.S. patent application Ser. No. 15/592,509, filed on May 11, 2017, entitled “Portable Mobile Robot and operation thereof”, all of which are fully incorporated herein by reference.

### TECHNICAL FIELD

The present invention relates to robot control field, and in particular relates to a portable mobile robot and operation method thereof, which can provide home interaction service.

### BACKGROUND

With the increasing popularity of smart devices, the portable mobile robots become common in various aspects, such as logistics, home care, etc. However, such portable mobile robots lack an ability to correct travel paths based on a configuration and layout of a space in which the robots are located.

### SUMMARY

The present invention discloses a portable mobile robot, including: a capture module, configured to capture location information of the portable mobile robot; a processor module, coupled to the capture module, configured to draw a room map of the room in which the portable mobile robot is located based on the captured location information, and perform positioning, navigation, and path planning according to the room map; a control module, coupled to the processor module, configured to send a control signal to control movement of the portable mobile robot in the room along the a path according to the room map; a motion module, configured to control operation of a motor to drive the portable mobile robot according to the control signal; and a tray with a concave bottom, which is mounted on the top of the portable mobile robot.

Advantageously, in the present invention, the portable mobile robot and operation method thereof can provide home interaction service.

### BRIEF DESCRIPTION OF THE DRAWINGS

FIG. 1 is a top view of a portable mobile robot according to one embodiment of the present invention.

FIG. 2 is a bottom view of a portable mobile robot according to one embodiment of the present invention.

FIG. 3 is a stereogram of a portable mobile robot according to one embodiment of the present invention.

FIG. 4 is a left view and a right view of a portable mobile robot according to one embodiment of the present invention.

FIG. 5 illustrates a block diagram of a portable mobile robot according to one embodiment of the present invention.

FIG. 6 illustrates a block diagram of a processor module in the portable mobile robot according to one embodiment of the present invention.

FIG. 7 illustrates a flowchart of an operation method for a portable mobile robot at the user end according to one embodiment of the present invention.

FIG. 8 illustrates a flowchart of an operation method for a portable mobile robot according to one embodiment of the present invention.

FIG. 9 is a top view of a portable mobile robot according to one embodiment of the present invention.

FIG. 10 is a bottom view of a portable mobile robot according to one embodiment of the present invention.

FIG. 11 is a top view of a portable mobile robot according to one embodiment of the present invention.

FIG. 12 is a top view of a portable mobile robot according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The present disclosure is directed to providing a portable mobile robot with a vision navigation function, optionally in combination with other auxiliary features, such as mobile speakers, and electronic alarm, etc. Embodiments of the present portable mobile robot can navigate through a room by using sensors in combination with a mapping ability to avoid obstacles that, if encountered, could interfere with the portable mobile robot's progress through the room.

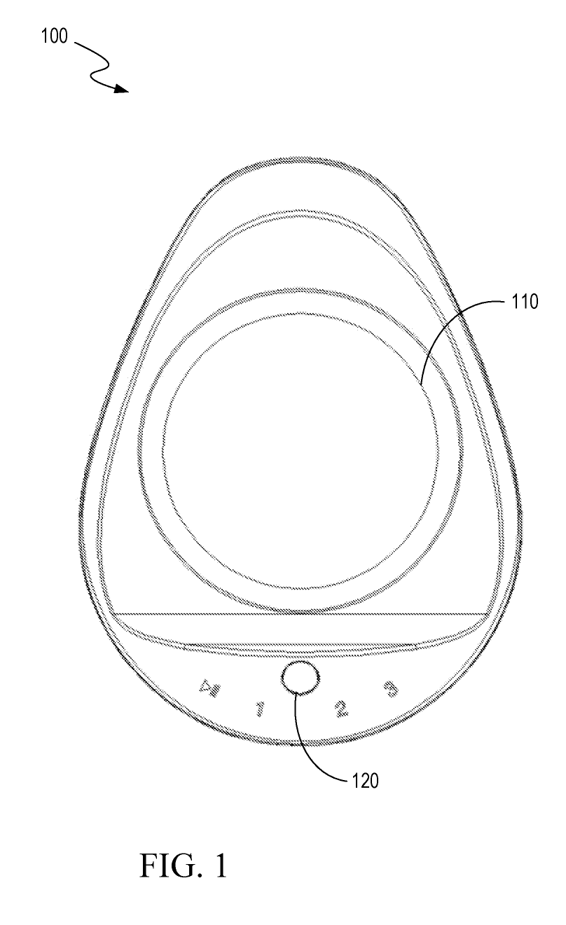

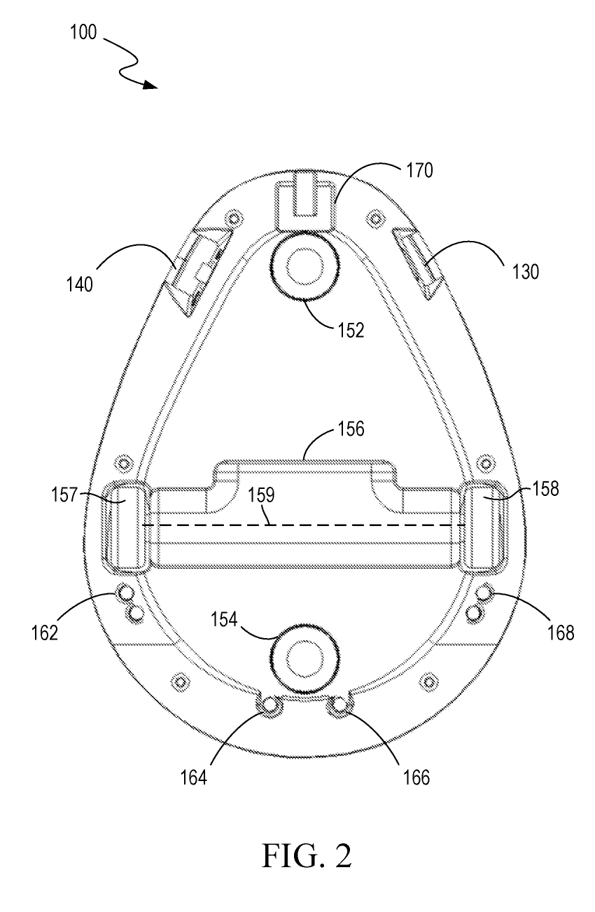

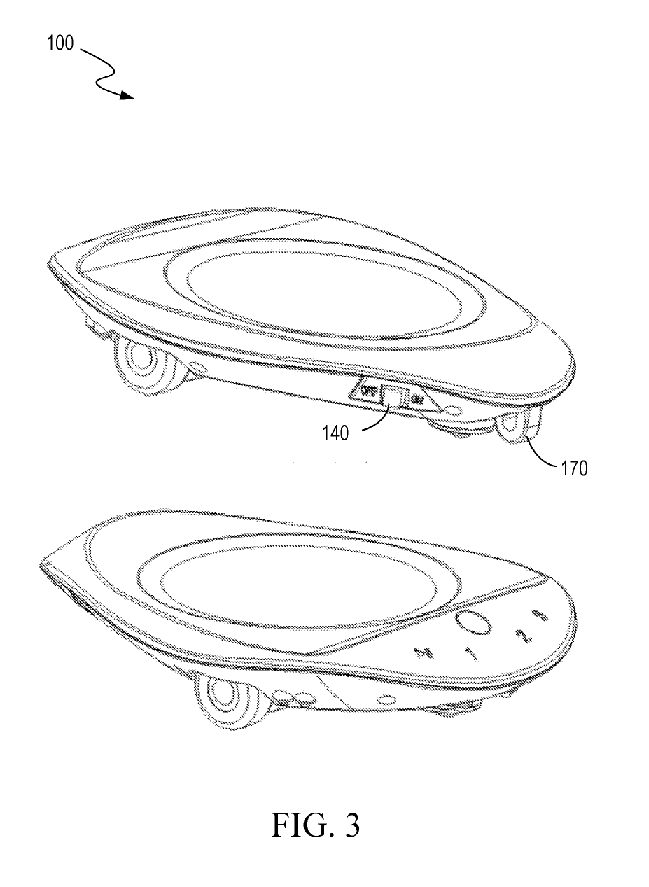

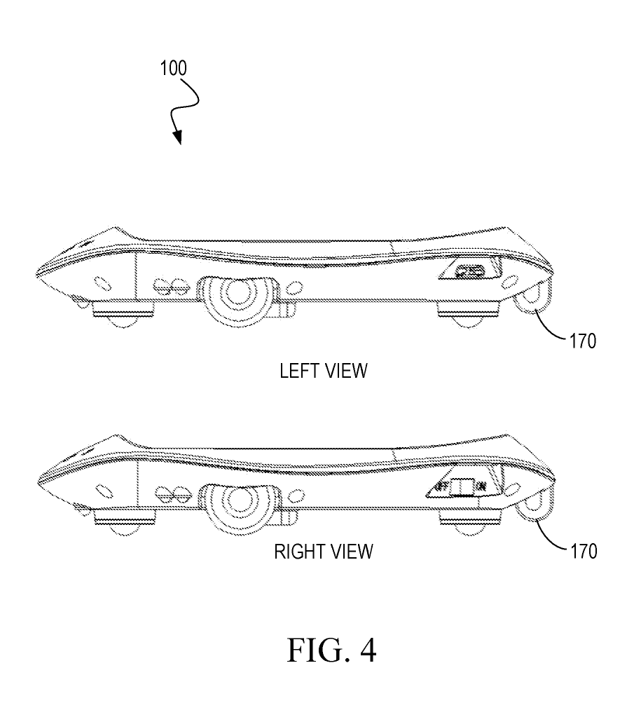

FIG. 1 is a top view of a portable mobile robot 100 according to one embodiment of the present invention. FIG. 2 is a bottom view of a portable mobile robot 100 according to one embodiment of the present invention. FIG. 3 is a stereogram of a portable mobile robot 100 according to one embodiment of the present invention. FIG. 4 is a left view and a right view of a portable mobile robot 100 according to one embodiment of the present invention.

As shown in FIG. 1-FIG. 4, according to the one embodiment of the present invention, the portable mobile robot 100 includes a tray 110, a camera 120, a USB interface 130, an ON/OFF switch 140, a pair of universal wheels 152 and 154, a pair of driving wheels 156, infrared distance sensors 162 and 168 configured to sense the distance from the obstacles of two sides of the portable mobile robot 100, infrared cliff sensors 164 and 166 configured to prevent dropping down, and a hook 170.

In one embodiment, the tray 110 is mounted on the top of the portable mobile robot 100. The tray 110 can have a concave bottom to carry user's water cup, coffee cup, keys, or toys, and provide service and surprise for the user. In another embodiment, the tray 110 can be configured to carry a wireless camera, which can connect to a WIFI network, or other wireless communication network, and transmit real-time video to the user's device (e.g., mobile phone, computer, etc), so as to achieve home security cruise. In another embodiment, the tray 110 can be configured to carry a wireless speaker, making the portable mobile robot 100 be a mobile music player.

In one embodiment, the camera 120 is mounted on the top of the portable mobile robot 100. The camera 120 can be configured to capture surrounding images (e.g., ceiling image), which can be used for surrounding map construction.

In one embodiment, the USB interface 130 can be coupled to a USB cable extending to a device external of the portable mobile robot 100 for charging that external device, or performing data communication with the external device.

In one embodiment, the ON/OFF switch 140 can be a toggle switch, which is configured to control the turn on and off of the portable mobile robot 100.

In one embodiment, the universal wheels 152 and 154 can be universal balls. Universal balls are spherical in shape, and protrude downward from a bottom surface of the portable mobile robot 100 as shown in FIG. 4. The diameter of the universal balls is greater than the diameter of an aperture in the bottom of the portable mobile robot 100, thereby preventing the universal balls from falling from the portable mobile robot 100. However, the universal balls rest in a socket formed in the bottom of the portable mobile robot 100, and are not confined to rotate about a fixed axis of rotation. Instead, the universal balls can rotate in any direction within the sockets. According to alternate embodiments, the universal balls can be confined to rotate about a specific axis of rotation, but this axis of rotation can be pivotally coupled to the portable mobile robot 100. Thus, the axis of rotation of the universal balls can pivot, again allowing the universal balls to roll in any angular direction relative to the bottom of the portable mobile robot 100.

In one embodiment, the driving wheel assembly 156 can include a plurality of wheels 157, 158 pivotally connected to a support shaft 159, shown using hidden lines in FIG. 2. Unlike the embodiments of the universal wheels 152, 154 described above, the driving wheels 157, 158 are rotated by a motor or other source of rotational force as described below to cause movement of the portable mobile robot 100. The driving wheels 157, 158 can optionally be independently drivable, meaning that each driving wheel 157, 158 can be rotated at speeds and times, and optionally angular directions selected independent of the speeds, times, and angular directions of the other driving wheel 158. Driving each of the wheels 157, 158 differently allows the direction of the portable mobile robot 100 to be controlled without the need for a separate, dedicated steering wheel.

In one embodiment, the distance sensors 162 and 168 and/or the cliff sensors 164 and 166 can be infrared sensors, ultrasonic sensors, capacitive sensors, or any other type of non-contact sensor. For example, the distance sensors 162 and 168 can each include two infrared sensors, configured to measure the distance of the portable mobile robot 100 from a left side obstacle and a right side obstacle, respectively. The cliff sensors 164 and 166 can be configured to measure the distance separating a portion of the portable mobile robot 100 from the ground. If the distance from the ground is greater than a preset threshold, or suddenly changes faster than a preset threshold rate of change, then it is determined that the portable mobile robot 100 is approaching a cliff or other sudden drop or elevation change that poses a risk that the portable mobile robot 100 will fall down or otherwise be unable to navigate such an elevation change, so the forward motion should be stopped.

In one embodiment, the hook 170 (FIG. 4) can be configured to hang or otherwise couple a fuzzy ball or other pet toy to the portable mobile robot 100. With the movement of the portable mobile robot 100, a dog or cat can follow the pet toy and achieve the purpose of exercise. In another embodiment, the portable mobile robot 100 can also have another hook at the front (not shown), so that two or more portable mobile robot 100 can be connected end to end, and form a robot team.

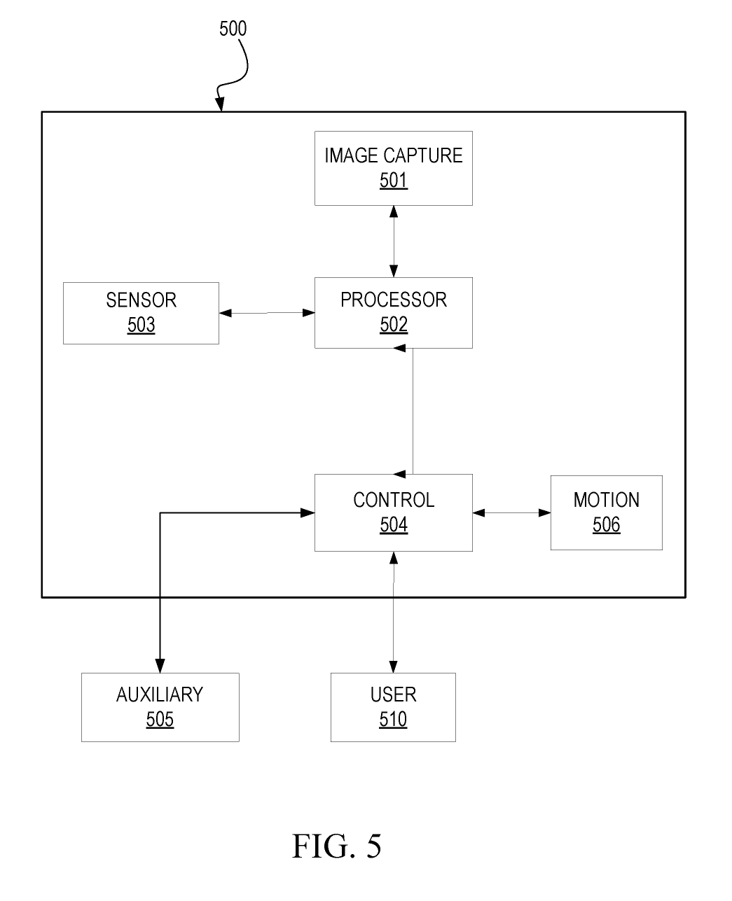

FIG. 5 illustrates a block diagram of a portable mobile robot 500 according to one embodiment of the present invention. As shown in FIG. 5, the portable mobile robot 500 includes an image capture module 501, a processor module 502, a sensor module 503, a control module 504, an auxiliary module 505, and a motion module 506. Each module described herein can be implemented as logic, which can include a computing device (e.g., structure: hardware, non-transitory computer-readable medium, firmware) for performing the actions described. As another example, the logic may be implemented, for example, as an ASIC programmed to perform the actions described herein. According to alternate embodiments, the logic may be implemented as stored computer-executable instructions that are presented to a computer processor, as data that are temporarily stored in memory and then executed by the computer processor. In one embodiment, the image capture module 501 (e.g., the camera 120) in the portable mobile robot 500 can be configured to capture surrounding images (e.g., ceiling image), which can be used for surrounding map construction. The sensor module 503 can be configured to include at least one of the distance sensors 162 and 168 and/or the cliff sensors 164 and 166, for example, and optionally other control circuitry to capture the location information related to the portable mobile robot 500 (e.g., distances from the obstacle and ground). The sensor module 503 can optionally include a gyroscope, an infrared sensor, or any other suitable type of sensor for sensing the presence of an obstacle, a change in the portable mobile robot's direction and/or orientation, and other properties relating to navigation of the portable mobile robot 500.

According to the data captured by the image capture module 501 and the sensor module 503, the processor module 502 can draw the room map of the portable mobile robot, store the current location of the portable mobile robot, store feature point coordinates and related description information, and perform positioning, navigation, and path planning. For example, the processor module 502 plans the path from a first location to a second location for the portable mobile robot. The control module 504 (e.g., a micro controller MCU) coupled to the processor module 502 can be configured to send a control signal to control the motion of the portable mobile robot 500. The motion module 506 can be a driving wheel with driving motor (e.g., the universal wheels 152 and 154, the driving wheel 156), which can be configured to move according to the control signal. The auxiliary module 505 is an external device to provide auxiliary functions according to user's requirement, such as the tray 110 and the USB interface 130.

The user 510 can give command about the motion direction of the portable mobile robot 500, and the expected function of the portable mobile robot 500.

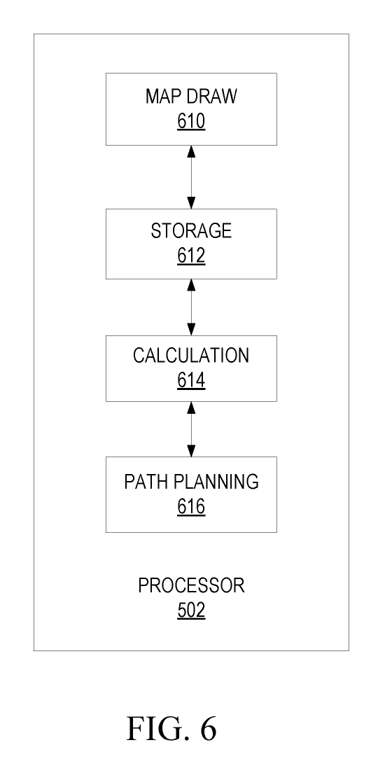

FIG. 6 illustrates a block diagram of the processor module 502 in the portable mobile robot 500 according to one embodiment of the present invention. FIG. 6 can be understood in combination with the description of FIG. 5. As shown in FIG. 6, the processor module 502 includes a map draw unit 610, a storage unit 612, a calculation unit 614, and a path planning unit 616.

The map draw unit 610 can be configured as part of the image capture module 501, processor module 502, or a combination thereof, to draw the room map of the portable mobile robot 500 according to the images captured by the image capture module 501 (as shown in FIG. 5), include information about feature points, and obstacles, etc. The images can optionally be assembled by the map draw unit 610 to draw the room map. According to alternate embodiments, edge detection can optionally be performed to extract obstacles, reference points, and other features from the images captured by the image capture module 501 to draw the room map.

The storage unit 612 stores the current location of the portable mobile robot in the room map drawn by the map draw unit 610, image coordinates of the feature points, and feature descriptions. For example, feature descriptions can include multidimensional description for the feature points by using ORB (oriented fast and rotated brief) feature point detection method.

The calculation unit 614 extracts the feature descriptions from the storage unit, matches the extracted feature descriptions with the feature description of the current location of the portable mobile robot, and calculates the accurate location of the portable mobile robot 500.

The path planning unit 616 takes the current location as the starting point of the portable mobile robot 500, refers to the room map and the destination, and plans the motion path for the portable mobile robot 500 relative to the starting point.

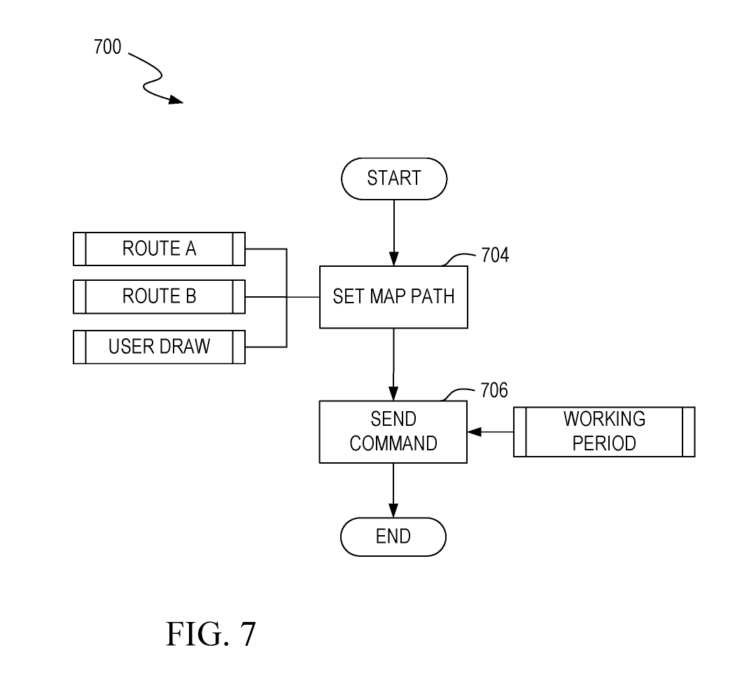

FIG. 7 illustrates a flowchart of an operation method 700 for a portable mobile robot at the user end according to one embodiment of the present invention. FIG. 7 can be understood in combination with the description of FIGS. 1-6. As shown in FIG. 7, the operation method 700 for the portable mobile robot can include:

Step 704: the user 510 sets a map path in APP software installed on a mobile or handheld device. The map path can include the given route of the map information in the processor module 502, such as route A and route B. The map path can also include the map drawn by the user. For example, the user can preset some routes. When the user presses the corresponding button on the portable mobile robot (e.g., buttons 1, 2, 3 shown in FIG. 1), the portable mobile robot will move according to the preset route. Furthermore, the user can also set the working period of the portable mobile robot (e.g., auto working from 11 AM to 12 PM).

Step 706: sending a command (e.g., moving from point A to point B) to the portable mobile robot, i.e., sending the command to the processor module 502 in the portable mobile robot 500.

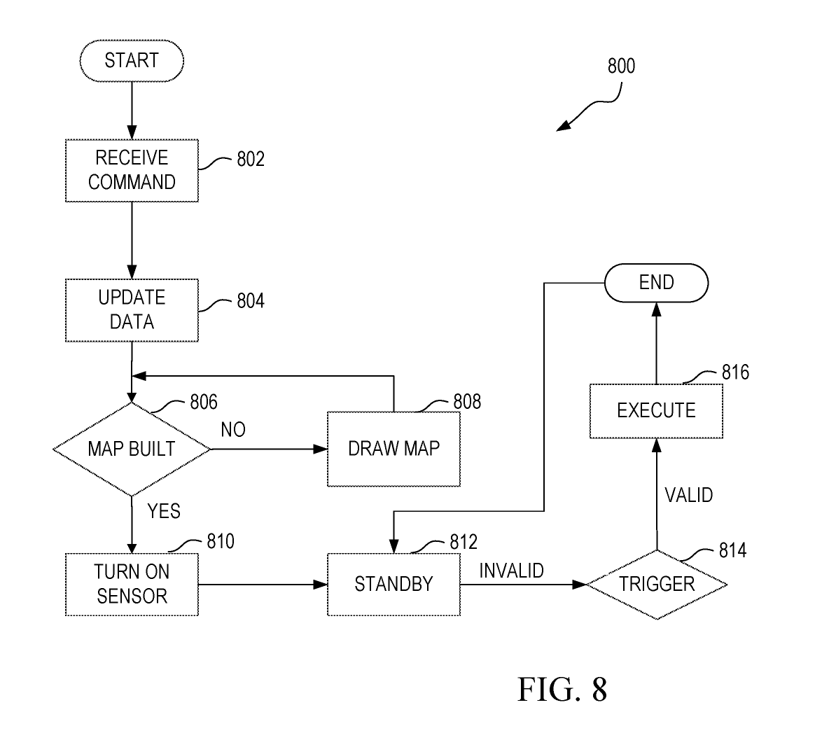

FIG. 8 illustrates a flowchart of an operation method 800 for a portable mobile robot according to one embodiment of the present invention. FIG. 8 can be understood in combination with the description of FIGS. 1-7. As shown in FIG. 8, the operation method 800 for the portable mobile robot can include:

Step 802: the processor module 502 in the portable mobile robot 100 receives the command from the user. For example, the user clicks the start menu on the A PP software installed on a mobile or handheld device to generate a start command. At this time, the portable mobile robot 100 can turn around or play music to show that it starts working;

Step 804: the processor module 502 updates a configuration data. For example, the configuration data can include the clock information, e.g., time and date;

Step 806: the processor module 502 determines whether the map path information has been built. If the map path information has been built, the operation method 800 goes to step 810, i.e., turning on the sensors. If the map path information has not been built, the operation method 800 goes to step 808, the operation method 800 stays at step 806 when the processor module 502 draws the map and builds the path, until the map information has been built;

Step 812: the portable mobile robot 100 returns to the starting point and standby;

Step 814: wait for the trigger event. For example, the user 105 presses the button to trigger the portable mobile robot 100;

Step 816: execute the command sent by the user 105. For example, the portable mobile robot moves according to the path;

Step 818: return to step 812 after executing the user's command and stay standby.

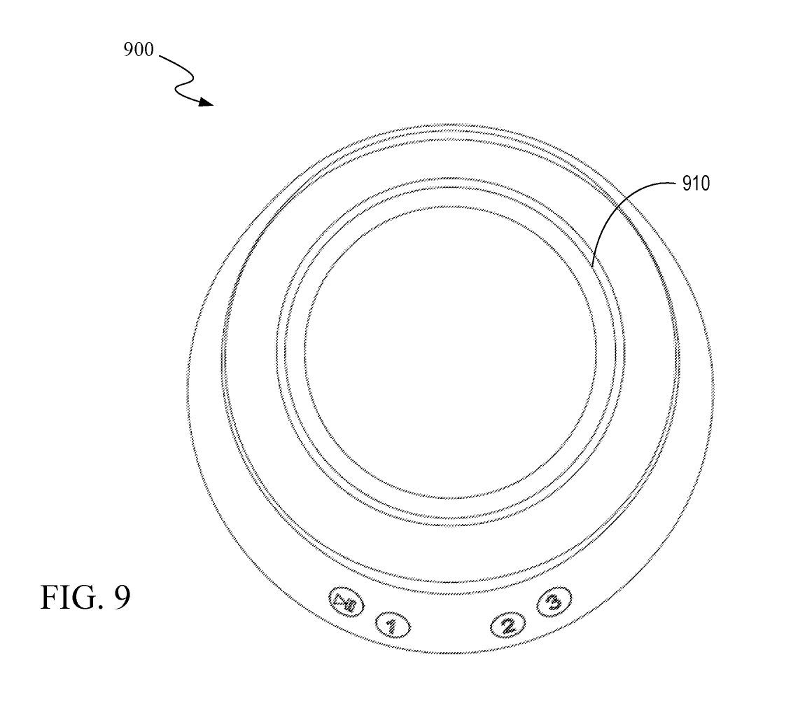

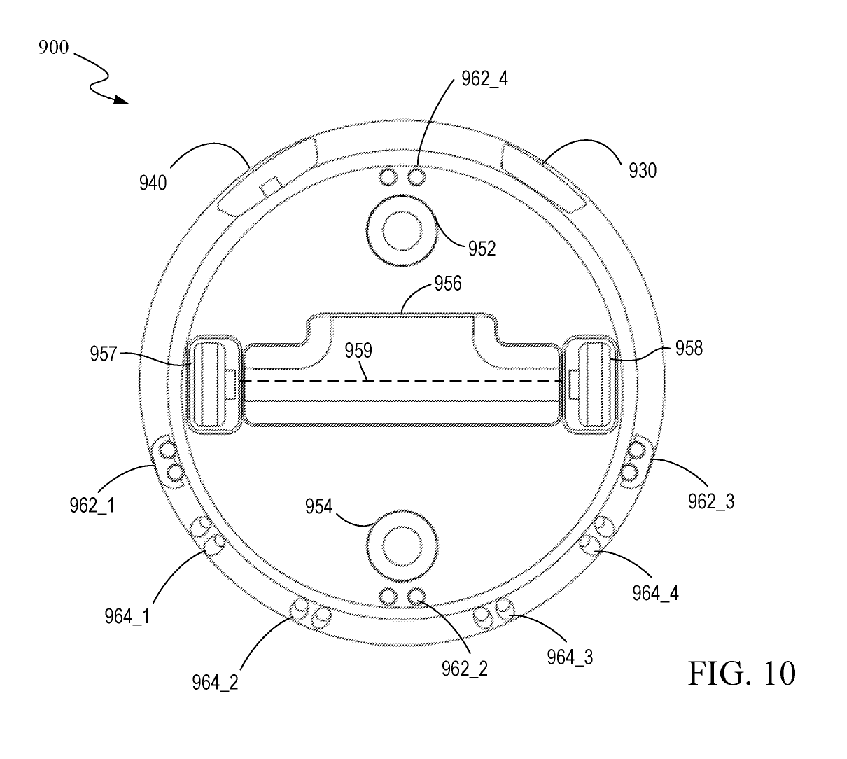

FIG. 9 is a top view of a portable mobile robot 900 according to one embodiment of the present invention. FIG. 10 is a bottom view of a portable mobile robot 900 according to one embodiment of the present invention. As shown in FIG. 9-FIG. 10, according to the one embodiment of the present invention, the portable mobile robot 900 includes a tray 910, a USB interface 930, an ON/OFF switch 940, a pair of universal wheels 952 and 954, a pair of driving wheels 956, cliff sensors 962_1 to 962_4 configured to prevent dropping down, and distance sensors 964_1 to 964_4 configured to sense the distance from the obstacles of the portable mobile robot 900.

In one embodiment, the tray 910 is mounted on the top of the portable mobile robot 900. The tray 910 can have a concave bottom to carry user's water cup, coffee cup, keys, or toys, and provide service and surprise for the user. In another embodiment, the tray 110 can be configured to carry a wireless camera, which can connect to a WIFI network, or other wireless communication network, and transmit real-time video to the user's device (e.g., mobile phone, computer, etc), so as to achieve home security cruise. In another embodiment, the tray 110 can be configured to carry a wireless speaker, making the portable mobile robot 100 be a mobile music player. In yet another embodiment, the tray 110 can be configured to carry smoke, fire, gas leak, noise sensors, so as to prevent home accidents.

In one embodiment, the USB interface 930 can be coupled to a USB cable extending to a device external of the portable mobile robot 900 for charging that external device, or performing data communication with the external device.

In one embodiment, the ON/OFF switch 940 can be a toggle switch, which is configured to control the turn on and off of the portable mobile robot 900.

In one embodiment, the universal wheels 952 and 954 can be universal balls. Universal balls are spherical in shape, and protrude downward from a bottom surface of the portable mobile robot 900 as shown in FIG. 10. The diameter of the universal balls is greater than the diameter of an aperture in the bottom of the portable mobile robot 900, thereby preventing the universal balls from falling from the portable mobile robot 900. However, the universal balls rest in a socket formed in the bottom of the portable mobile robot 900, and are not confined to rotate about a fixed axis of rotation. Instead, the universal balls can rotate in any direction within the sockets. According to alternate embodiments, the universal balls can be confined to rotate about a specific axis of rotation, but this axis of rotation can be pivotally coupled to the portable mobile robot 900. Thus, the axis of rotation of the universal balls can pivot, again allowing the universal balls to roll in any angular direction relative to the bottom of the portable mobile robot 900.

In one embodiment, the driving wheel assembly 956 can include a plurality of wheels 957, 958 pivotally connected to a support shaft 959, shown using hidden lines in FIG. 10. Unlike the embodiments of the universal wheels 952, 954 described above, the driving wheels 157, 158 are rotated by a motor or other source of rotational force as described below to cause movement of the portable mobile robot 900. The driving wheels 957, 958 can optionally be independently drivable, meaning that each driving wheel 957, 958 can be rotated at speeds and times, and optionally angular directions selected independent of the speeds, times, and angular directions of the other driving wheel 158. Driving each of the wheels 957, 958 differently allows the direction of the portable mobile robot 100 to be controlled without the need for a separate, dedicated steering wheel.

In one embodiment, the cliff sensors 962_1 to 962_4 and/or the distance sensors 964_1 to 964_4 can be infrared sensors, ultrasonic sensors, capacitive sensors, or any other type of non-contact sensor. For example, the distance sensors 964_1 to 964_4 can be configured to measure the distance of the portable mobile robot 100 from obstacles. The cliff sensors 962_1 to 962_4 can be configured to measure the distance separating a portion of the portable mobile robot 900 from the ground. If the distance from the ground is greater than a preset threshold, or suddenly changes faster than a preset threshold rate of change, then it is determined that the portable mobile robot 900 is approaching a cliff or other sudden drop or elevation change that poses a risk that the portable mobile robot 900 will fall down or otherwise be unable to navigate such an elevation change, so the forward motion should be stopped.

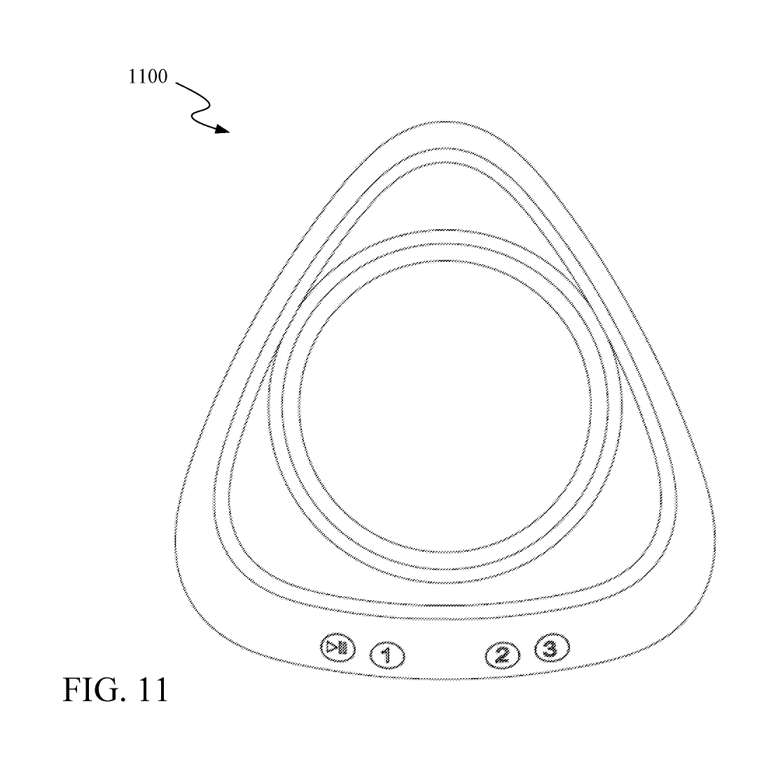

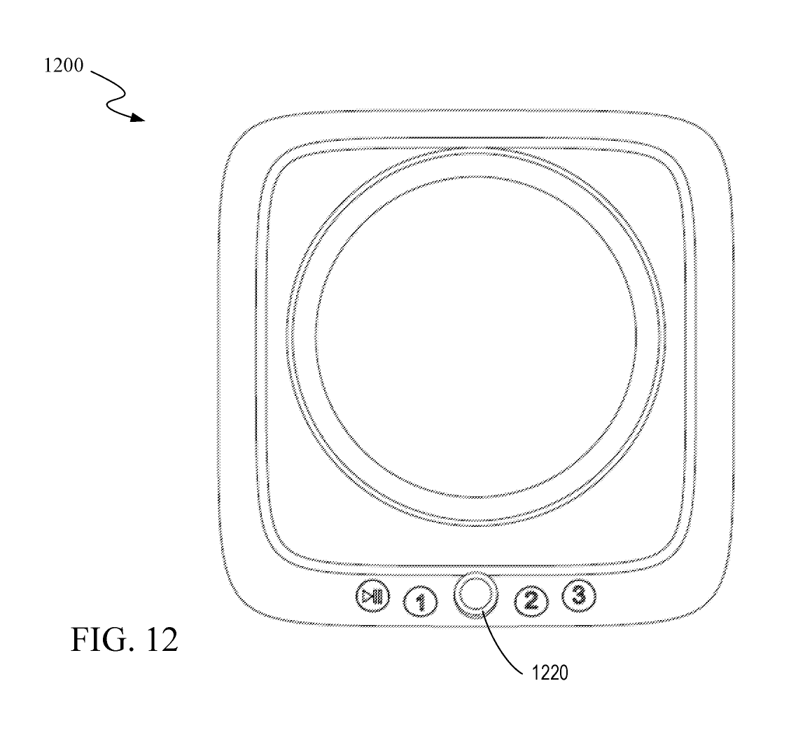

In the example of FIG. 9 and FIG. 10, the housing of the portable mobile robot 900 is circular. In other examples, the housing of the portable mobile robot can be triangular (as FIG. 11 shown) or rectangular (as FIG. 12 shown). One skilled in the art should understand that the housing of the portable mobile robot can be any suitable shape, which is not the limitation of the invention.

Unlike the embodiments of FIG. 1 to FIG. 8, the portable mobile robot 900 does not have the camera 120 mounted on the top. Instead, the portable mobile robot 900 uses the cliff sensors 962_1 to 962_4 and the distance sensors 964_1 to 964_4 to collect the location information for surrounding map construction. The absence of the camera 120 may reduce the positioning accuracy, but it can reduce cost, which is applicable to general requirements.

The portable mobile robot 900 can include a capture module (e.g., the cliff sensors 962_1 to 962_4 and the distance sensors 964_1 to 964_4), a processor module, a control module, an auxiliary module, and a motion module. Each module described herein can be implemented as logic, which can include a computing device (e.g., structure: hardware, non-transitory computer-readable medium, firmware) for performing the actions described. As another example, the logic may be implemented, for example, as an ASIC programmed to perform the actions described herein. According to alternate embodiments, the logic may be implemented as stored computer-executable instructions that are presented to a computer processor, as data that are temporarily stored in memory and then executed by the computer processor. In one embodiment, the capture module can be configured to collect the location information for surrounding map construction (e.g., distances from the obstacle and ground). According to the location information, the processor module can draw the room map of the portable mobile robot, store the current location of the portable mobile robot, store feature point coordinates and related description information, and perform positioning, navigation, and path planning. For example, the processor module plans the path from a first location to a second location for the portable mobile robot. The control module (e.g., a micro controller MCU) coupled to the processor module can be configured to send a control signal to control the motion of the portable mobile robot. The motion module can be a driving wheel with driving motor (e.g., the universal wheels 952 and 954, the driving wheel 956), which can be configured to move according to the control signal.

The auxiliary module is an external device to provide auxiliary functions according to user's requirement, such as the tray 910. The tray 910 can have a concave bottom to carry user's water cup, coffee cup, keys, or toys, and provide service and surprise for the user. In another embodiment, the tray 110 can be configured to carry a wireless camera, which can connect to a WIFI network, or other wireless communication network, and transmit real-time video to the user's device (e.g., mobile phone, computer, etc), so as to achieve home security cruise. In another embodiment, the tray 110 can be configured to carry a wireless speaker, making the portable mobile robot 100 be a mobile music player. In yet another embodiment, the tray 110 can be configured to carry smoke, fire, gas leak, noise sensors, so as to prevent home accidents.

The user can give command about the motion direction of the portable mobile robot 900, and the expected function of the portable mobile robot 900.

In other embodiments, the portable mobile robot can combine at least one of VSLAM technology, infrared sensor technology, gyroscope sensor technology, and laser scanning technology to achieve the capture module in the portable mobile robot 900 and perform the step of collecting the location information. For example, the portable mobile robot 1100 in FIG. 11 can include a built-in gyroscope, to collect the displacement and rotation angle of the portable mobile robot 1100. The portable mobile robot 1200 in FIG. 12 can include a laser scanner on the top, to transmit laser beams to scan surrounding environment, and to receive the reflected laser beams to form three-dimensional (3D) environmental map.

Advantageously, in the present invention, the portable mobile robot and operation method thereof can provide home interaction service.

While the foregoing description and drawings represent embodiments of the present invention, it will be understood that various additions, modifications and substitutions may be made therein without departing from the spirit and scope of the principles of the present invention. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, and not limited to the foregoing description.

What is claimed is:

1. A portable mobile robot, comprising:
a capture module, configured to capture location information of the portable mobile robot;
a processor module, coupled to the capture module, configured to draw a room map of the room in which the portable mobile robot is located based on the captured location information, and perform positioning, navigation, and path planning according to the room map;
a control module, coupled to the processor module, configured to send a control signal to control movement of the portable mobile robot in the room along the a path according to the room map;
a motion module, configured to control operation of a motor to drive the portable mobile robot according to the control signal; and
a tray with a concave bottom, which is mounted on the top of the portable mobile robot.

2. The portable mobile robot according to claim 1, wherein the capture module comprises an image capture module, the image capture module is mounted on the top of the portable mobile robot and configured to capture a ceiling image.

3. The portable mobile robot according to claim 1, wherein the capture module comprises an infrared distance sensor configured to sense a distance from obstacles, and an infrared cliff sensor configured to sense a change in elevation of the portable mobile robot to interfere with the portable mobile robot dropping down over the change in elevation.

4. The portable mobile robot according to claim 1, wherein the capture module comprises a gyroscope, to collect the displacement and rotation angle of the portable mobile robot.

5. The portable mobile robot according to claim 1, wherein the capture module comprises a laser scanner, to transmit laser beams to scan surrounding environment, and to receive the reflected laser beams to form three-dimensional environmental map.

6. The portable mobile robot according to claim 1, wherein the processor module is configured to plan the path from a first location to a second location for the portable mobile robot according to the surrounding image and the location information.

7. The portable mobile robot according to claim 1, wherein the motion module comprises a pair of universal wheels and a pair of driving wheels.

8. The portable mobile robot according to claim 1, wherein the housing of the portable mobile robot is circular.

9. The portable mobile robot according to claim 1, wherein the housing of the portable mobile robot is triangular.

10. The portable mobile robot according to claim 1, wherein the housing of the portable mobile robot is rectangular.
